(19) United States
(12) Patent Application Publication
(10) Pub. No.: US 2004/0153654 A1
(43) Pub. Date: Aug. 5, 2004

(54) Data recording apparatus and data reading apparatus

(76) Inventors: Yuji Handa, Nagano (JP); Kazuki Takahashi, Nagano (JP)

Correspondence Address: BIRCH STEWART KOLASCH & BIRCH, PO BOX 747, FALLS CHURCH, VA, 22040-0747, US

(21) Appl. No.: 10/761,410

(22) Filed: Jan. 22, 2004

(30) Foreign Application Priority Data
Jan. 23, 2003 (JP) 2003-014219

(51) Int. Cl. H04L 9/00

(52) U.S. Cl. 713/182

(57) ABSTRACT

The data recording and reading apparatus includes a unit for encrypting data and a unit for decrypting encrypted data, further a user can optionally determine a password. The apparatus comprises: a personal computer for determining the password; a memory storing data; the unit for encrypting the stored data on the basis of the password; a unit for writing the encrypted data on a recording medium; the unit for decrypting the encrypted data on the basis of the password; and a unit for controlling the determining unit, the memory, the encrypting unit, the writing unit and the decrypting unit.

### BACKGROUND OF THE INVENTION

The present invention relates to a data recording apparatus and a data reading apparatus.

Conventionally, data are encrypted, by encrypting programs, so as to keep secrecy of the data. Encrypting programs encrypt data on the basis of algorithms defined therein. To access to the encrypted data, a user inputs a password, which has been assigned, then the encrypted data are decrypted on the basis of a decrypting algorithm, which corresponds to an encrypting algorithm. The user can access to and use the data after the data are decrypted.

Namely, data are encrypted and decrypted by programs, but a data recording and reading apparatus, which is capable of encrypting and decrypting data, is disclosed in Japanese Patent Gazette No. 01-227272.

However, the Japanese Patent Gazette does not describe about a password, which is an important factor of data encryption. Determining a password by user and an encrypting process based on the password are not described. In the apparatus, ordinary data are merely encrypted on the basis of an algorithm stored in a data encrypting unit.

Anybody can easily decrypt the data, which are encrypted by the apparatus disclosed in the Japanese Patent Gazette, by the same apparatus, so that the secrecy of the data cannot be kept.

Further, encrypting ordinary data by encrypting programs and decrypting encrypted data by decrypting programs apply great loads to a CPU of a computer. Therefore, the computer cannot work smoothly while encrypting and decrypting data.

### SUMMARY OF THE INVENTION

An object of the present invention is to provide a data recording apparatus, which includes means for encrypting data and means for decrypting encrypted data and in which a user can optionally determine a password.

To achieve the object, the present invention has following structures.

Namely, a first basic structure is a data recording apparatus comprising:

means for determining a password;

means for storing data;

means for encrypting the stored data on the basis of the password inputted;

means for writing the encrypted data on a recording medium; and

means for controlling the determining means, the storing means, the encrypting means and the writing means.

With this structure, a user can optionally determine the password, so that secrecy of data can be kept. Since the data recording apparatus is capable of encrypting data, no load for encrypting data is applied to an external apparatus, e.g., a personal computer, and working efficiency of the external apparatus can be increased. Further, no encrypting programs for the external apparatus are required.

A second basic structure is a data reading apparatus comprising:

means for inputting a password, which has been previously determined;

means for reading encrypted data from a recording medium;

means for decrypting the encrypted data on the basis of the password inputted; and

means for controlling the inputting means, the reading means and the decrypting means.

With this structure, the data reading apparatus is capable of decrypting data, so no load for decrypting data is applied to an external apparatus, e.g., a personal computer, and working efficiency of the external apparatus can be increased. Further, no decrypting programs for the external apparatus are required.

A third basic structure is a data recording and reading apparatus comprising:

means for determining a password;

means for storing data;

means for encrypting the stored data on the basis of the password inputted;

means for writing the encrypted data on a recording medium;

means for inputting the password, which has been previously determined;

means for reading encrypted data from the recording medium;

means for decrypting the encrypted data read by the reading means on the basis of the password inputted; and

means for controlling the determining means (41), the inputting means, the storing means, the encrypting means, the writing means, the reading means and the decrypting means,

wherein the controlling means controls the encrypting means to encrypt the stored data on the basis of the password and controls the writing means to write the encrypted data on the recording medium, and

the controlling means controls the reading means to read encrypted data from the recording medium and controls the decrypting means to decrypt the encrypted data on the basis of the password.

With this structure, a user can optionally determine the password, so that secrecy of data can be kept. Since the data recording and reading apparatus is capable of encrypting and decrypting data, no load for encrypting and decrypting data is applied to an external apparatus, e.g., a personal computer, and working efficiency of the external apparatus can be increased. Further, no encrypting programs and decrypting programs for the external apparatus are required.

In the apparatus, an ancillary password may be previously stored in the storing means,

the controlling means may add the ancillary password to the password inputted, and

the encrypting means may encrypt the stored data on the basis of the combined password.

With this structure, attributes of the data can be defined when the data are decrypted. Further, secrecy of data can be further improved even if the password is known by others.

The apparatus may further comprise means for storing an ancillary password,

the controlling means may add the ancillary password to the password inputted, and the decrypting means may decrypt the encrypted data on the basis of the combined password.

With this structure, the encrypted data, to which attributes are given, can be decrypted.

In the apparatus, the inputting means may be capable of selecting if the password is stored in the storing means or the password and an ancillary password are stored in the storing means.

With this structure, a user needs not to determine the password for each use. If the apparatus is used by limited users using a common password, only the limited users can decrypt the data. Secrecy of data can be kept within the limited users.

In the apparatus, the ancillary password may be a datum of the apparatus.

With this structure, attributes of the data can be easily known.

In the apparatus, a plurality of the ancillary passwords may be stored in the storing means.

With this structure, secrecy of data can be further improved.

In the apparatus, hush function data may be stored in the storing means, and

the controlling means may convert the password or a combination of the password and the ancillary password into a hush value on the basis of the hush function data, and

the encrypting means may encrypt the stored data on the basis of the hush value.

With this structure, variations of secrecy, which are caused by passwords determined by users, can be uniform. Further, length of encryption keys can be fixed, so processing data can be easily performed.

In the apparatus, hush function data may be stored in the storing means, and

the controlling means may convert the password or a combination of the password and the ancillary password into a hush value on the basis of the hush function data, and

the decrypting means may decrypt the encrypted data on the basis of the hush value.

With this structure too, variations of secrecy, which are caused by passwords determined by users, can be uniform. Further, length of encryption keys can be fixed, so processing data can be easily performed.

In the apparatus, the inputting means may be capable of selecting if the hush value of the password is stored in the storing means or the hush value of the combination of the password, and

the ancillary password is stored in the storing means.

With this structure, a user needs not to determine the password for each use. If the apparatus is used by limited users using a common password, only the limited users can easily access to data. Secrecy of the data can be kept within the limited users.

In the apparatus, the recording medium may be a removable medium.

With this structure, the recording medium can be used in other apparatuses, whose environments are equal to that of the apparatus. Therefore, the encrypted data can be decrypted by other apparatuses. Further, only the limited users can easily access to the data by their apparatuses as common data.

### BRIEF DESCRIPTION OF THE DRAWINGS

Embodiments of the present invention will now be described by way of examples and with reference to the accompanying drawings, in which:

FIG. 1 is a block diagram of a data recording and reading apparatus of a first embodiment of the present invention;

FIG. 2 is a flowchart of data processing by the data recording and reading apparatus of the first embodiment;

FIG. 3 is a block diagram of a data recording and reading apparatus of a second embodiment of the present invention; and

FIG. 4 is a flowchart of data processing by the data recording and reading apparatus of the second embodiment.

### DETAILED DESCRIPTION OF THE EMBODIMENTS

Preferred embodiments of the present invention will now be described in detail with reference to the accompanying drawings.

### First Embodiment

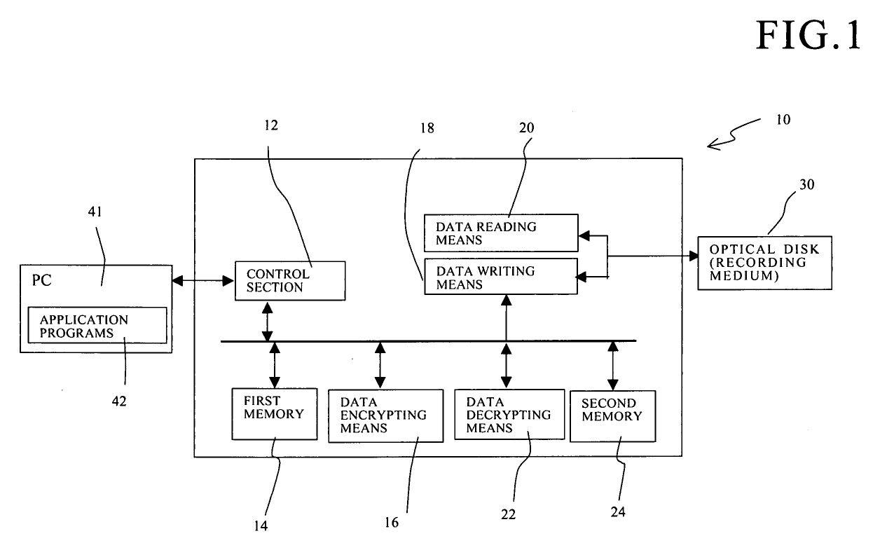

An outline of a data recording and reading apparatus of a first embodiment will be explained with reference to FIG. 1. The data recording and reading apparatus of the first embodiment is an optical disk player having an encrypting function.

The optical disk player 10 includes a personal computer (PC) 41, which acts as means for determining a password and means for inputting the password. The personal computer 41 has application programs 42. The optical disk player 10 further includes: a first memory 14, which act as means for temporally storing ordinary data sent from the PC 41, etc.; encrypting means 16, which encrypts the data stored in the first memory 14 on the basis of the password; data writing means 18, which writes the data encrypted by the encrypting means 16 on a recording medium 30, e.g., a removal optical disk; data reading means 20, which reads the encrypted data from the optical disk 30; decrypting means 22, which decrypts the encrypted data on the basis of the password; a second memory 24 storing ancillary passwords; and a control section 12, which controls the PC 41, the memory 14, the encrypting means 16, the data writing means 18, the data reading means 20, the decrypting means 22 and the second memory 24. Further, an external apparatus, e.g., a computer, may be connected to the control section 12.

In the present embodiment, the encrypting means 16 and the decrypting means 22 are separated as independent means or units, but the control section 12 including a CPU, etc. may act as the encrypting means and the decrypting means.

Further, one optical pick-up may act as the data writing means and the data reading means.

Note that, the ordinary data means data not encrypted.

The application programs 42 are installed in memories (not shown) of the PC 41. A user can input commands to the control section 12 via the PC 41.

The user can select if the data writing means 18 writes ordinary data on the optical disk 30 or the data writing means 18 writes encrypted data on the optical disk 30. A command for selecting a type of writing data can be inputted via the PC 41. Namely, the user can optionally select the type or writing data.

In the case of writing encrypted data on the optical disk 30, a plurality of decryption rules may be established by application programs 42. For example, the encrypted data written on the optical disk 30 can be decrypted by only the optical disk player 10, which have encrypted the data; the encrypted data written on the optical disk 30 can be decrypted by limited users only; and the encrypted data written on the optical disk 30 can be decrypted by other optical disk players.

If the user selects to encrypt ordinary data by the encrypting means 16 and write the encrypted data on the optical disk 30 by the data writing means 18, the user selects the decryption rule, too.

Generally, a password is required to encrypt ordinary data by the encrypting means 16. The password is an optional character string. In the present embodiment, the decryption rule is also optionally selected by the user, so ancillary passwords for indicating the decryption rules have been determined. Further, the ancillary passwords improve the secrecy of data with the password.

The ancillary passwords are, for example, data of the optical disk player 10, e.g., a serial number of the optical disk player 10, a type of the optical disk player 10, a name of a group whose members are permitted to access to encrypted data. The ancillary passwords have been previously stored in the second memory 24. Further, some ancillary passwords may be determined before shipment; some ancillary password may be determined by users. For example, the users select the ancillary password via the PC 41.

The password, which has been determined by the user, and the ancillary password are combined, and the combined password acts as an encryption key. Therefore, even if a third person gets the password, he or she cannot decrypt the encrypted data without the ancillary password. Note that, the encryption key may be constituted by the password only.

Further, the encryption key may be substantially constituted by the ancillary password. In this case, the combined password may be constituted by the password including no characters (blanks or spaces only) and the ancillary password.

The encrypting means 16 encrypts ordinary data on the basis of a prescribed encrypting algorithm, which is selected form many known cryptosystems. In the present embodiment, the combined password including the password determined by the user and the ancillary password is used as the encryption key. For example, the key encryption may be used as a key of a private key cryptosystem, e.g., DES. The cryptosystem is not limited.

The encrypting means 16 encrypt ordinary data on the basis of the encryption key constituted by the password, which is determined by the user and which may include blanks only, and the ancillary password. Then, the encrypted data are sent to the data writing means 18 and written on the optical disk 30. On the other hand, the decrypting means 22 decrypts the encrypted data on the basis of a decrypting algorithm which corresponds to the prescribed encrypting algorithm of the encrypting means 16.

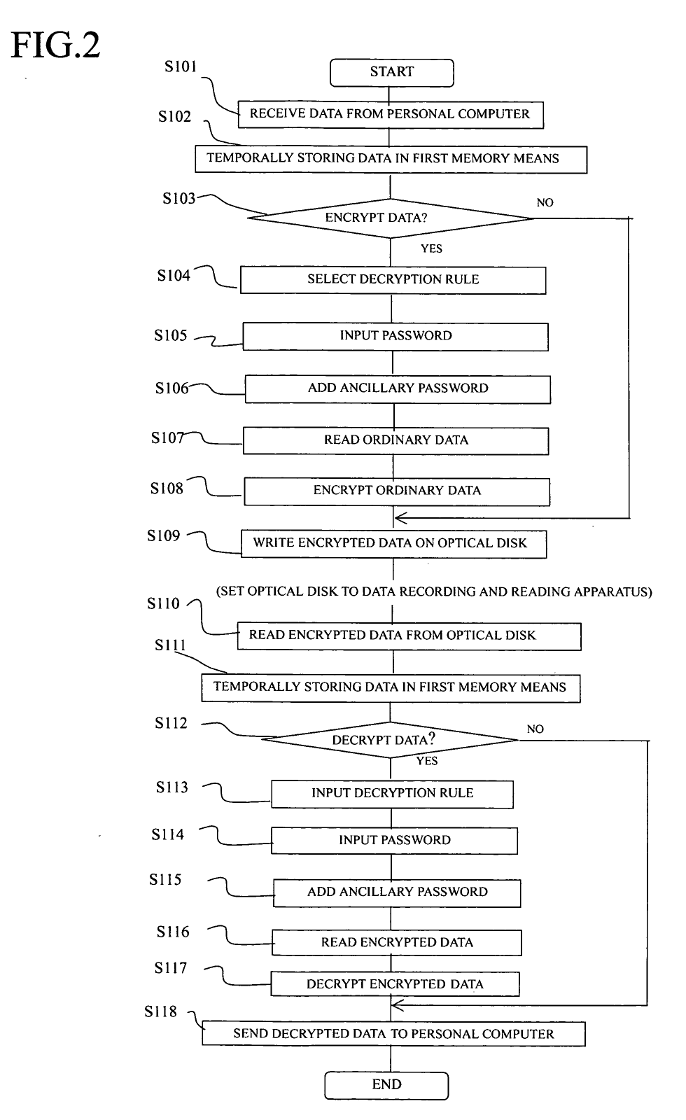

The action of the optical disk player 10 of the first embodiment will be explained with reference to a flowchart of FIG. 2.

Ordinary data are inputted via the PC 41 (Step S101). Note that, ordinary data may be sent from an external apparatus, e.g., a computer. The ordinary data inputted are temporally stored in the first memory 14 (Step S102). The user selects if the optical disk player 10 encrypts the ordinary data or not via the PC 41 (Step S103).

At the Step S103, if the user does not select to execute the encryption, the ordinary data are written on the optical disk 30 as they are. Namely, the control section 12 sends the ordinary data to the data writing means 18 and writes them on the optical disk 30 as the ordinary data.

On the other hand, at the Step S103, if the user selects to execute the encryption, a command for performing the encryption is sent to the control section 12 from the PC 41. Then, the user selects the decryption rule (Step S104).

After selecting the decryption rule, the user determines the password for encrypting the data and inputs the same to the control section 12 via the PC 41 (Step S105). Upon receiving the password, the control section 12 selects the ancillary password, which has been stored in the second memory 24, on the basis of the decryption rule, and adds the ancillary password to the password (Step S106). By adding the ancillary password to the password, the combined password or the encryption key is determined. The control section 12 retrieve the ordinary data from the first memory 14 (Step S107), then the encrypting means 16 encrypts the ordinary data on the basis of the combined password as the encryption key (Step S108). The encrypted data are sent to the data writing means 18, and the data writing means 18 writes the encrypted data on the optical disk 30 (Step S109).

When the encrypted data are decrypted, the user sets the optical disk 30, on which the encrypted data have been written, in the optical disk player 10. Then, the control section 12 reads the encrypted data by the data reading means 20 (Step S110). The encrypted data read by the data reading means 20 are temporally stored in the first memory 14 (Step S111). The user selects if the optical disk player 10 decrypts the encrypted data or not via the PC 41 (Step S112). At the Step S112, if the user selects to execute the decryption, a command for performing the decryption is sent to the control section 12 from the PC 41. Then, the user inputs the decryption rule via the PC 41 (Step S113). If user inputs a wrong decryption rule, the control section 12 shows “ERROR” on a display screen (not shown) of the PC 41. After inputting the decryption rule, the user inputs the password, which has been determined to encrypt the ordinary data, via the PC 41 (Step S114). Then, the control section 12 add the ancillary password to the password to form the combined password or the encryption key (Step S115).

The control section 12 retrieves the encrypted data from the first memory 14 and sends them to the data decrypting means 22 (Step S116). The decrypting means 22 decrypts the encrypted data on the basis of the combined password or the encryption key (Step S117). At the Steps S113 and S114, the decryption rule and the password are confirmed, so that the correct combined password is formed at the Step S115. Therefore, the encrypted data are correctly converted to the ordinary data. The converted ordinary data are sent to the PC 41 (Step S118), so that the user can use the converted ordinary data. Note that, the control section 12 may sends the converted ordinary data to the external apparatus connected to the optical disk player 10.

At the Step S114, if user inputs a wrong password, a wrong combined password is formed, so that the data decrypting means 22 decrypts the encrypted data on the basis of the wrong combined password. Therefore, the data cannot be correctly decrypted, so that the user cannot use the converted ordinary data.

Note that, at the Step S112, if the user selects not to execute the decryption, the control section 12 stops the action.

### Second Embodiment

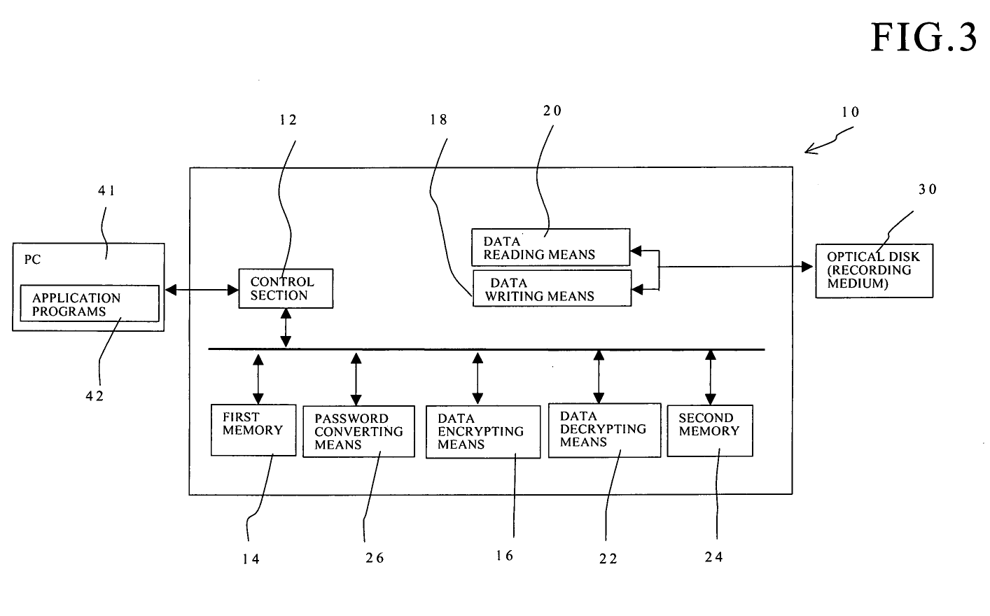

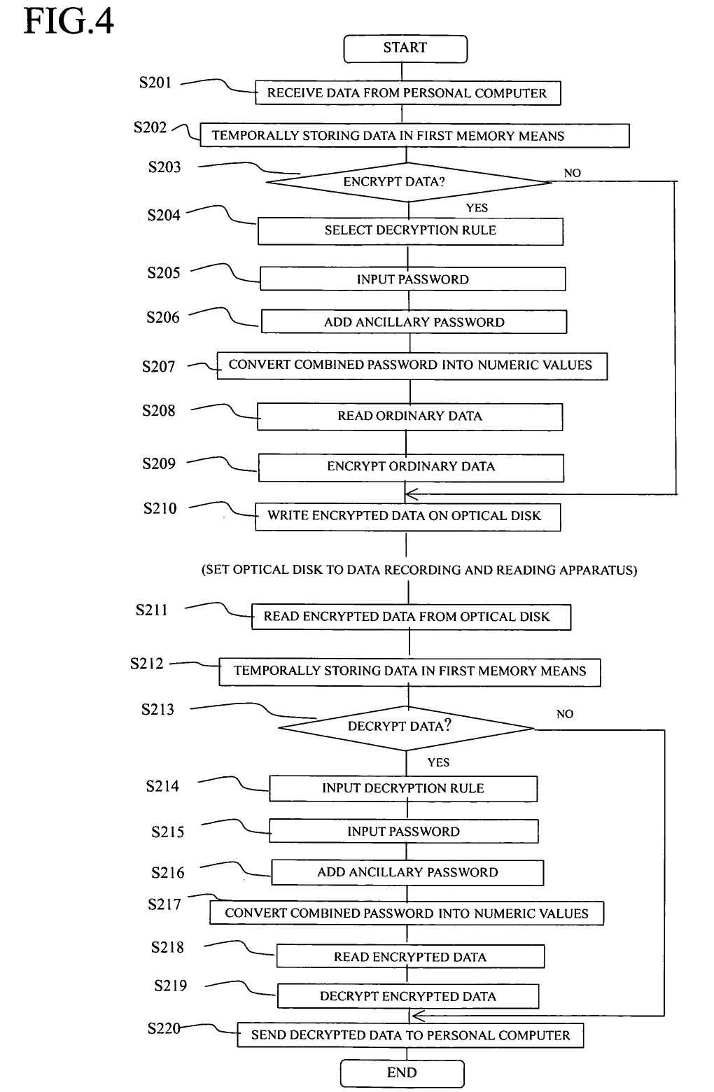

A data recording and reading apparatus of a second embodiment will be explained with reference to FIGS. 3 and 4.

In the first embodiment, the encryption and the decryption are performed on the basis of the combined password or the encryption key, which is constituted by the password determined by the user and the ancillary password relating to the selected decryption rule.

On the other hand, in the second embodiment, the optical disk player 10 (the data recording and reading apparatus) further includes a password converting means 26. When the ordinary data are encrypted and the encrypted data are decrypted, the password or the combined password (the character string) is converted to a numeric value or values on the basis of a prescribed function. Namely, the numeric value or values are used as a key for encryption and decryption.

FIG. 3 shows a structure of the optical disk player of the present embodiment. The elements described in the first embodiment are assigned the same symbols, and explanation will be omitted.

The password converting means 26 converts the password or the combined password, which is a character string including the password and the ancillary password, to numeric values. There many processes to convert a character string to numeric values. In the present embodiment, the character string is converted by hush function. The hush function is a one-way function, so it is substantially impossible to know the original character string. By using the hush function, the secrecy of data can be improved.

The action of the optical disk player 10 of the second embodiment will be explained with reference to a flowchart of FIG. 4.

Ordinary data are inputted via the PC 41 (Step S201). Note that, ordinary data may be sent from an external apparatus, e.g., a computer. The ordinary data inputted are temporally stored in the first memory 14 (Step S202). The user selects if the optical disk player 10 encrypts the ordinary data or not via the PC 41 (Step S203).

At the Step S203, if the user does not select to execute the encryption, the ordinary data are written on the optical disk 30 as they are. Namely, the control section 12 sends the ordinary data to the data writing means 18 and writes them on the optical disk 30 as the ordinary data.

On the other hand, at the Step S203, if the user selects to execute the encryption, a command for performing the encryption is sent to the control section 12 from the PC 41. Then, the user selects the decryption rule (Step S204).

After selecting the decryption rule, the user determines the password for encrypting the data and inputs the same to the control section 12 via the PC 41 (Step S205). Upon receiving the password, the control section 12 selects the ancillary password, which has been stored in the second memory 24, on the basis of the decryption rule, and adds the ancillary password to the password (Step S206). The password converting means 26 converts the combined password to hush values (Step S207). Then, the control section 12 retrieves the ordinary data from the first memory 14 and sends them to the data encrypting means 16. The data encrypting means 16 encrypts the ordinary data on the basis of the hush values, which are converted from the password, as an encryption key (Step S209). The encrypted data are sent to the data writing means 18, and the data writing means 18 writes the encrypted data on the optical disk 30 (Step S210).

When the encrypted data are decrypted, the user sets the optical disk 30, on which the encrypted data have been written, in the optical disk player 10. Then, the control section 12 reads the encrypted data by the data reading means 20 (Step S211). The encrypted data read by the data reading means 20 are temporally stored in the first memory 14 (Step S212). The user selects if the optical disk player 10 decrypts the encrypted data or not via the PC 41 (Step S213). At the Step S213, if the user selects to execute the decryption, a command for performing the decryption is sent to the control section 12 from the PC 41. Then, the user inputs the decryption rule via the PC 41 (Step S214). If user inputs a wrong decryption rule, the control section 12 shows “ERROR” on a display screen (not shown) of the PC 41. After inputting the decryption rule, the user inputs the password, which has been determined to encrypt the ordinary data, via the PC 41 (Step S215). Then, the control section 12 add the ancillary password to the password to form the combined password or the encryption key (Step S216). Then, the password converting means 26 converts the combined password to hush values (Step S217).

The control section 12 retrieves the encrypted data from the first memory 14 and sends them to the data decrypting means 22 (Step S218). The decrypting means 22 decrypts the encrypted data on the basis of the hush values converted from the combined password as the encryption key (Step S219). At the Steps S214 and S215, the decryption rule and the password are confirmed, so that the correct combined password is formed at the Step S216. Therefore, the encrypted data are correctly converted to the ordinary data. The converted ordinary data are sent to the PC 41 (Step S220), so that the user can use the converted ordinary data. Note that, the control section 12 may sends the converted ordinary data to the external apparatus connected to the optical disk player 10.

At the Step S215, if user inputs a wrong password, a wrong combined password is formed, so that the data decrypting means 22 decrypts the encrypted data on the basis of the wrong combined password. Therefore, the data cannot be correctly decrypted, so that the user cannot use the converted ordinary data.

Note that, at the Step S213, if the user selects not to execute the decryption, the control section 12 stops the action.

If the hush values are once stored in the second memory 24, the password and the decryption rule need not be inputted for each encryption and decryption. In the case that the optical disk player 10 can be used by limited users only, the users can easily and efficiently encrypt and/or decrypt data without inputting the password and the decryption rule.

The present invention is not limited to the first and the second embodiments.

In the above described embodiments, the data are encrypted and decrypted in the data recording and reading apparatus 10. But ordinary data may be encrypted by an external apparatus and decrypted in the data recording and reading apparatus 10. In this case, the decryption algorithm of the data decrypting means 22 must be corresponded to an encrypting algorithm of an encrypting program of the external apparatus. Namely, the data recording and reading apparatus 10 can decrypt data without installing the encrypting program in the PC 41.

In the above described embodiments, the data are encrypted and decrypted by a private key cryptosystem. But a public key cryptosystem may be employed.

Further, the ancillary password may be an optional character string instead of the data of the data recording and reading apparatus 10. The ancillary password may be determined by user and stored in the second memory 24.

The determining means and the inputting means may be provided to a body proper of the data recording and reading apparatus 10 instead of the PC 41.

Further, the recording medium 30 may be a removal medium or a fixed medium, and various types of media, e.g., optical disks, magnetic disks, optical-magnetic disks, can be used as the recording medium.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A data recording apparatus, comprising:
means for determining a password;
means for storing data;
means for encrypting the stored data on the basis of the password inputted;
means for writing the encrypted data on a recording medium; and
means for controlling said determining means, said storing means, said encrypting means and said writing means.

2. A data reading apparatus, comprising:
means for inputting a password, which has been previously determined;
means for reading encrypted data from a recording medium;
means for decrypting the encrypted data on the basis of the password; and
means for controlling said inputting means, said reading means and said decrypting means.

3. The data recording apparatus according to claim 1,
wherein an ancillary password is previously stored in said storing means,
said controlling means adds the ancillary password to the password inputted, and
said encrypting means encrypts the stored data on the basis of the combined password.

4. The data reading apparatus according to claim 2,
further comprising means for storing an ancillary password,
wherein said controlling means adds the ancillary password to the password inputted, and
said decrypting means decrypts the encrypted data on the basis of the combined password.

5. A data recording apparatus, comprising:
means for determining a password;
means for storing data and hush function data;
means for encrypting the stored data;
means for writing the encrypted data on a recording medium; and
means for controlling said storing means, said determining means, said encrypting means and said writing means,
wherein said controlling means converts the password into a hush value on the basis of the hush function data, and said encrypting means encrypts the stored data on the basis of the hush value.

6. A data reading apparatus, comprising:
means for inputting a password, which has been previously determined;
means for storing hush function data;
means for reading encrypted data from a recording medium;
means for decrypting the encrypted data; and
means for controlling said inputting means, said storing means, said reading means and said decrypting means,
wherein said controlling means converts the password into a hush value on the basis of the hush function data, and said decrypting means decrypts the encrypted data on the basis of the hush value.

7. The data recording apparatus according to claim 5,
wherein an ancillary password is previously stored in said storing means, and
said controlling means adds the ancillary password to the password inputted and converts the combined password into a hush value on the basis of the hush function data.

8. The data reading apparatus according to claim 6,
wherein an ancillary password is previously stored in said storing means, and
said controlling means adds the ancillary password to the password inputted and converts the combined password into a hush value on the basis of the hush function data.
